(19) United States
(12) Patent Application Publication
(10) Pub. No.: US 2020/0401159 A1
(43) Pub. Date: Dec. 24, 2020

(54) CAR WASH JUDGMENT SYSTEM AND CAR WASH JUDGMENT METHOD

(71) Applicant: TOYOTA JIDOSHA KABUSHIKI KAISHA, Toyota-shi (JP)

(72) Inventor: Kentaro ASAI, Toyota-shi (JP)

(73) Assignee: TOYOTA JIDOSHA KABUSHIKI KAISHA, Toyota-shi (JP)

(21) Appl. No.: 16/907,155

(22) Filed: Jun. 19, 2020

(30) Foreign Application Priority Data
Jun. 20, 2019 (JP) 2019-114863

(51) Int. Cl. G05D 1/02; G01C 21/34; G06Q 50/10

(52) U.S. Cl. CPC G05D 1/0276; G06Q 50/10; G01C 21/34

(57) ABSTRACT

In a car wash judgment system, an acquirer acquires traveling information of a vehicle. A condition retaining unit retains a certain car wash condition. A judgment unit judges whether or not traveling information acquired at the acquirer satisfies the certain car wash condition. An unpaved road information retaining unit retains unpaved road information indicating the position of an unpaved road. The certain car wash condition includes traveling on an unpaved road by the vehicle. When a vehicle that has transmitted traveling information is an automated driving vehicle capable of performing automated driving and when the traveling information of the automated driving vehicle satisfies the certain car wash condition, a car wash instruction unit transmits an instruction signal for moving the automated driving vehicle to a car wash station.

### BACKGROUND

### 1. Technical Field

The present disclosure relates to a technology for judging car wash timing of a vehicle.

### 2. Description of Related Art

JP-A-2015-219811 discloses a vehicle control system for allowing a vehicle parked in a parking lot to move out of there by automated driving. The vehicle control system allows a vehicle to move from a parking space to a standby area in a parking lot by automated driving, places the vehicle on standby in a standby order based on the scheduled leaving time set in advance, and allows, when an occupant of the vehicle arrives at an exit of the parking lot, the vehicle to move to the exit by automated driving. Also, when a vehicle is to be provided with a car wash service, the vehicle control system allows the vehicle to move to a washing position of an automatic car-washing machine and stop there.

Meanwhile, when an owner or a manager of a vehicle cannot notice or judge a state of the vehicle with a dirty outer surface, the car wash service cannot be sometimes provided at appropriate timing.

### SUMMARY

A general purpose of the present disclosure is to provide a technology for facilitating judgment on car wash timing of a vehicle.

In response to the above issue, a car wash judgment system according to one aspect of the present disclosure includes an acquirer configured to acquire traveling information of a vehicle, a condition retaining unit configured to retain a certain car wash condition, and a judgment unit configured to judge whether or not traveling information acquired at the acquirer satisfies the certain car wash condition.

Another aspect of the present disclosure is a car wash judgment method. The method includes acquiring traveling information of a vehicle, retaining a certain car wash condition, and judging whether or not acquired traveling information satisfies the certain car wash condition.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a diagram used to describe an overview of a car wash judgment system according to an embodiment;

FIG. 2 shows a functional configuration of the car wash judgment system according to the embodiment; and

FIG. 3 is a flowchart of car wash judgment processing according to the embodiment.

### DETAILED DESCRIPTION

An embodiment will now be described. The embodiment is illustrative and is not intended to be limiting.

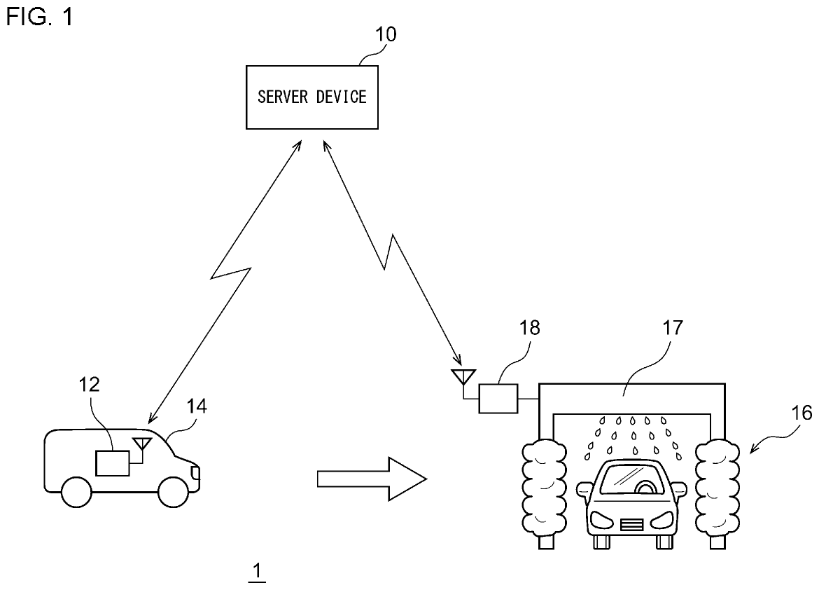

FIG. 1 is a diagram used to describe an overview of a car wash judgment system 1. The car wash judgment system 1 includes a server device 10, an automated driving vehicle 14, and a car wash station 16. The automated driving vehicle 14 has a wireless communication function and includes a vehicle-mounted device 12 connected to the server device 10 via a network, such as the Internet.

The number of automated driving vehicle 14 is not limited to one, and, in the car wash judgment system 1, a situation is assumed in which each of multiple automated driving vehicles 14 generates traveling information and periodically transmits the traveling information to the server device 10. The server device 10 is installed in a data center and receives the traveling information transmitted from the vehicle-mounted device 12 of each automated driving vehicle 14.

Each automated driving vehicle 14 is capable of performing a manual driving mode in which the driver performs driving operations, and an automated driving mode in which the vehicle moves by automated driving. In the automated driving mode, the automated driving vehicle 14 can automatically move to the car wash station 16 according to an instruction signal from the server device 10. The automated driving vehicle 14 may also be used for car sharing.

In the car wash station 16, an actuation control device 18 is provided to control car wash equipment 17. The actuation control device 18 has a wireless communication function and is connected to the server device 10 via a network. When an automated driving vehicle 14 is placed at the washing position of the car wash equipment 17, the actuation control device 18 actuates the car wash equipment 17. The actuation control device 18 may acquire, from the vehicle-mounted device 12 via the server device 10, information indicating that the automated driving vehicle 14 is placed at the washing position of the car wash equipment 17.

In the car wash judgment system 1, the server device 10 judges whether or not an automated driving vehicle 14 is to be washed based on a traveling history of the automated driving vehicle 14, and, when determining that the car washing is to be performed, the server device 10 transmits an instruction signal to the vehicle-mounted device 12. Upon reception of the instruction signal for performing the car washing, the vehicle-mounted device 12 performs control for moving the vehicle to the car wash station 16 to have the vehicle washed. Accordingly, car washing can be automatically performed at appropriate timing when an outer surface of the automated driving vehicle 14 is presumed to be dirty.

When an automated driving vehicle 14 is used for car sharing, the server device 10 outputs an instruction signal for performing car washing after the use of car sharing is finished and before the next use is started. Accordingly, the automated driving vehicle 14 can be washed before it is provided to the next user. Also, since a manager of the car sharing service can judge the timing for car washing without actually going to the parking lot to check the automated driving vehicle 14, the manager's time and effort can be saved.

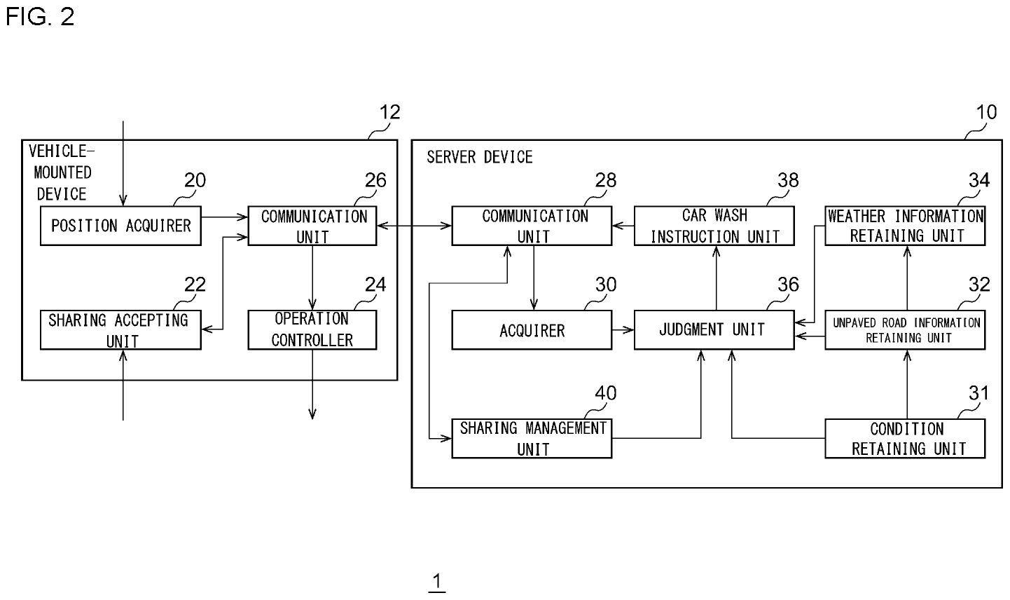

FIG. 2 shows a functional configuration of the car wash judgment system 1. Each of the elements represented by functional blocks for performing various processes shown in FIG. 2 can be implemented by a circuit block, a memory, an LSI or the like in terms of hardware, and by a program loaded into a memory or the like in terms of software. Accordingly, it will be obvious to those skilled in the art that these functional blocks may be implemented in a variety of forms by hardware only, software only, or a combination thereof, and the form is not limited to any of them.

The vehicle-mounted device 12 includes a position acquirer 20, a sharing accepting unit 22, an operation controller 24, and a communication unit 26. The server device 10 includes a communication unit 28, an acquirer 30, a condition retaining unit 31, an unpaved road information retaining unit 32, a weather information retaining unit 34, a judgment unit 36, a car wash instruction unit 38, and a sharing management unit 40.

The position acquirer 20 of the vehicle-mounted device 12 acquires position information of the vehicle and the time of the acquisition of the position information, and transmits the information and time to the server device 10 via the communication unit 26. The position information of the vehicle may be latitude and longitude acquired using a global positioning system (GPS), or may be a road link ID of a road on which the vehicle is traveling. The position information of the vehicle is traveling information that indicates a traveling position of the vehicle.

The sharing accepting unit 22 accepts use of car sharing. The sharing accepting unit 22 retains in advance authentication information of users, and, upon acceptance of identification information from a user, the sharing accepting unit 22 performs matching between the authentication information and identification information to perform authentication. When the authentication is successful, the sharing accepting unit 22 permits the use of car sharing. The sharing accepting unit 22 also accepts termination of use of car sharing from a user. The start time and finish time of use of car sharing are transmitted to the server device 10 via the communication unit 26. For example, a user may make a reservation of an automated driving vehicle 14 in advance, input the identification information to the sharing accepting unit 22 to start the use of the automated driving vehicle 14, and input the identification information to the sharing accepting unit 22 to finish the use of the automated driving vehicle 14. The automated driving vehicle 14 may be parked in a predetermined parking lot when use of the automated driving vehicle 14 is started and finished. The sharing accepting unit 22 may receive the identification information of a user from an IC card or a mobile terminal held by the user. The processing of user authentication may also be performed in the server device 10, and, in this case, the server device 10 receives the identification information of the user from the vehicle-mounted device 12 and performs authentication processing at the sharing management unit 40.

The operation controller 24 automatically performs driving operations for acceleration, steering, and braking in the automated driving mode to drive the vehicle. The operation controller 24 drives the vehicle along a targeted traveling route set in advance. The targeted traveling route defines a route from the current position to a destination, and the targeted traveling route from the parking lot to the car wash station 16 may be derived by the server device 10. The communication unit 26 transmits, to the server device 10, information regarding the use of car sharing and the traveling information of the vehicle with a vehicle ID attached thereto.

The acquirer 30 of the server device 10 acquires, as the traveling information, the position information of the automated driving vehicle 14 and the time of the acquisition of the position information, via the communication unit 28.

The condition retaining unit 31 retains a predetermined car wash condition. The predetermined car wash condition includes at least one of whether or not the vehicle has traveled on an unpaved road, whether or not the vehicle has traveled in bad weather, the travel distance after the last car washing, the time elapsed after the last car washing, and finishing the car washing in time for the next use of car sharing, for example.

The unpaved road information retaining unit 32 retains unpaved road information indicating the position of an unpaved road. The unpaved road information retained in the unpaved road information retaining unit 32 may be acquired from a first external server that retains road information. The unpaved road information may include a road link ID and whether or not the road is paved. Accordingly, whether or not the automated driving vehicle 14 has traveled on an unpaved road can be judged.

The weather information retaining unit 34 retains weather information for each area. The weather information retained in the weather information retaining unit 34 may be acquired from a second external server that retains weather information. Accordingly, whether or not the automated driving vehicle 14 has traveled in bad weather can be judged.

The sharing management unit 40 manages use of car sharing. The sharing management unit 40 accepts a reservation of the automated driving vehicle 14 from a user. The sharing management unit 40 also acquires the start time and finish time of use input to the sharing accepting unit 22.

The judgment unit 36 judges if the traveling information of a vehicle satisfies a predetermined car wash condition. The timing at which the judgment unit 36 performs car wash judgment processing may be set between the finish time of use and the start time of the subsequent use of car sharing. Accordingly, the judgment unit 36 performs the car wash judgment processing before the next user starts the use of the automated driving vehicle 14.

More specifically, when the traveling information of a vehicle indicates that the vehicle has traveled on an unpaved road for a predetermined distance or more, the judgment unit 36 judges that one car wash condition is satisfied, and, when the vehicle has not traveled on an unpaved road for the predetermined distance or more, the judgment unit 36 judges that the one car wash condition is not satisfied. Also, when the traveling information of a vehicle indicates that the vehicle has traveled in bad weather for a predetermined period of time or more, the judgment unit 36 judges that one car wash condition is satisfied, and, when the vehicle has not traveled in bad weather for the predetermined period of time or more, the judgment unit 36 judges that the one car wash condition is not satisfied. The bad weather does not mean sunny or cloudy weather but means weather that could cause a vehicle's outer surface to get dirty, such as rainy and snowy weather. In this way, whether or not an outer surface of a vehicle is dirty can be judged based on whether or not the vehicle has traveled on an unpaved road, and whether or not the vehicle has traveled in wet weather. Also, since judgment is conducted based on the traveling information of the vehicle, analysis of images capture by a vehicle-mounted camera or the like is unnecessary, enabling simple judgment with reduced processing loads.

Also, when the traveling information of a vehicle indicates that the vehicle has traveled for a predetermined distance or more after the last car washing, the judgment unit 36 judges that one car wash condition is satisfied, and, when the vehicle has not traveled for the predetermined distance or more after the last car washing, the judgment unit 36 judges that the one car wash condition is not satisfied. Also, when a predetermined period of time has elapsed after the last car washing, the judgment unit 36 judges that one car wash condition is satisfied, and, when the predetermined period of time has not elapsed after the last car washing, the judgment unit 36 judges that the one car wash condition is not satisfied.

The judgment unit 36 judges, as a predetermined car wash condition, if the vehicle can be washed in time for the next use of car sharing. More specifically, when it is indicated that the total time of transit time required for the moving to the car wash station 16 and moving to a predetermined parking lot by the automated driving vehicle 14 and car wash time required for the car washing by the car wash equipment 17 can be secured before the start time of the next use of car sharing, the judgment unit 36 judges that one car wash condition is satisfied, and, when it is indicated that the total time of the transit time and the car wash time cannot be secured before the start time of the next use, the judgment unit 36 judges that the one car wash condition is not satisfied. Based on the information regarding use of car sharing from the sharing management unit 40, the judgment unit 36 acquires the finish time of the use of car sharing and the start time of the next use. The start time of the use may be the time for which the reservation of the start of use has been made by the user.

When the traveling information of the vehicle satisfies a predetermined car wash condition, the car wash instruction unit 38 transmits an instruction signal for moving the vehicle to the car wash station 16. When the vehicle that has received the instruction signal is an automated driving vehicle 14, the automated driving vehicle 14 moves to the car wash station 16 and then moves from the car wash station 16 to a predetermined parking lot to be parked there according to automated driving control performed by the operation controller 24.

When the automated driving vehicle 14 is used for car sharing, the car wash instruction unit 38 transmits an instruction signal for moving the automated driving vehicle 14 to the car wash station 16 before use of the automated driving vehicle 14 is started, so that the car washing can be performed in time for the next use of car sharing.

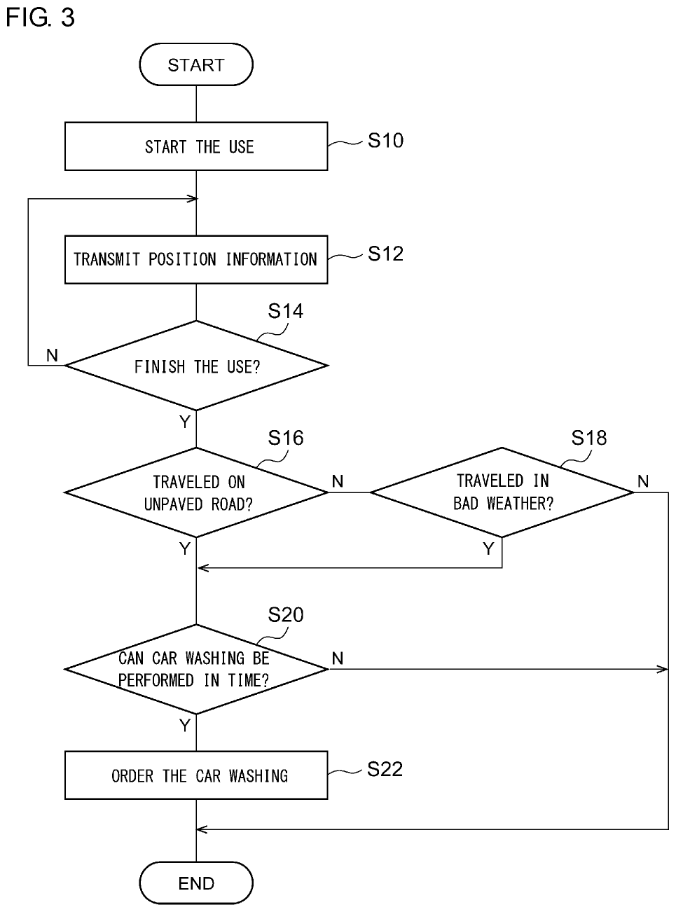

FIG. 3 is a flowchart of the car wash judgment processing. The sharing accepting unit 22 of the vehicle-mounted device 12 accepts the start of use of the automated driving vehicle 14 (S10), and the position acquirer 20 transmits the position information of the automated driving vehicle 14 to the server device 10 (S12).

Until the sharing accepting unit 22 accepts the termination of the use of car sharing (N at S14), the position information of the automated driving vehicle 14 is transmitted to the server device 10 (S12). When the sharing accepting unit 22 accepts the termination of the use of car sharing (Y at S14), the judgment unit 36 judges if the traveling information of the automated driving vehicle 14 indicates that the automated driving vehicle 14 has traveled on an unpaved road for a predetermined distance or more during the use of car sharing (S16). This can judge whether or not an outer surface of the vehicle is dirty.

When the automated driving vehicle 14 has not traveled on an unpaved road for the predetermined distance or more (N at S16), the judgment unit 36 judges if the traveling information of the automated driving vehicle 14 indicates that the automated driving vehicle 14 has traveled in bad weather (S18). This can also judge whether or not an outer surface of the vehicle is dirty. When the traveling information of the automated driving vehicle 14 indicates that the automated driving vehicle 14 has not traveled in bad weather for a predetermined period of time or more (N at S18), the processing is terminated without ordering car washing.

When the traveling information of the automated driving vehicle 14 indicates that the automated driving vehicle 14 has traveled in bad weather for the predetermined period of time or more (Y at S18), the judgment unit 36 judges whether or not washing the automated driving vehicle 14 can be finished by the start time of the next use of car sharing (S20). Also when the automated driving vehicle 14 has traveled on an unpaved road for the predetermined distance or more (Y at S16), the judgment unit 36 judges whether or not washing the automated driving vehicle 14 can be finished by the start time of the next use of car sharing (S20). When the wash of the automated driving vehicle 14 cannot be finished by the start time of the next use of car sharing (N at S20), the processing is terminated without ordering the car washing.

When the wash of the automated driving vehicle 14 can be finished by the start time of the next use of car sharing (Y at S20), the car wash instruction unit 38 judges that a predetermined car wash condition is satisfied and transmits an instruction signal for moving the automated driving vehicle 14 to the car wash station 16 (S22). Upon reception of the instruction signal, the operation controller 24 of the automated driving vehicle 14 automatically moves the automated driving vehicle 14 to the car wash station 16 and moves, when the car washing is finished, the automated driving vehicle 14 from the car wash station 16 to a predetermined parking lot. Thus, when an outer surface of a vehicle is presumed to be dirty and also when the vehicle can be washed in time for the next use of car sharing, the car washing is ordered. Accordingly, the automated driving vehicle 14 with the outer surface in a favorable state can be provided to a car sharing user.

The embodiment is intended to be illustrative only, and it will be obvious to those skilled in the art that various modifications to a combination of constituting elements could be developed and that such modifications also fall within the scope of the present disclosure.

Although the embodiment describes a mode in which the vehicle is an automated driving vehicle 14 used for car sharing, the mode is not limited thereto, and it may be a vehicle for manual driving owned by an individual. In this case, the server device 10 performs the car wash judgment processing based on the traveling information of the vehicle, and, when a car wash condition is satisfied, the server device 10 provides, to the vehicle-mounted device 12 or a personal mobile terminal, a notification indicating that car washing should be performed. In any case, whether or not car washing is necessary can be easily judged based on the traveling information of the vehicle.

Also, although the embodiment describes a mode in which the traveling information of a vehicle is the position information of the vehicle, the mode is not limited thereto. For example, the vehicle-mounted device 12 may generate traveling route information based on the position information of the vehicle, and the server device 10 may acquire the traveling route information from the vehicle-mounted device 12. For example, the vehicle-mounted device 12 may transmit, to the server device 10, the traveling route information when use of car sharing is finished. Also, the traveling information of a vehicle may be guidance route information used for a navigation function. In this way, the traveling information of a vehicle may be route information of the vehicle.

What is claimed is:

1. A car wash judgment system, comprising:
an acquirer configured to acquire traveling information of a vehicle;
a condition retaining unit configured to retain a predetermined car wash condition; and
a judgment unit configured to judge whether or not traveling information acquired at the acquirer satisfies the predetermined car wash condition.

2. The car wash judgment system according to claim 1, wherein the predetermined car wash condition includes traveling on an unpaved road.

3. The car wash judgment system according to claim 1,
wherein a vehicle that has transmitted traveling information is an automated driving vehicle capable of performing automated driving,
the car wash judgment system further comprising a car wash instruction unit configured to transmit, when the traveling information of the automated driving vehicle satisfies the predetermined car wash condition, an instruction signal for moving the automated driving vehicle to a car wash station.

4. The car wash judgment system according to claim 3, wherein
the automated driving vehicle is used for car sharing,
the judgment unit judges whether or not the predetermined car wash condition is satisfied before use of the automated driving vehicle is started, and,
when the traveling information of the automated driving vehicle satisfies the predetermined car wash condition, the car wash instruction unit transmits an instruction signal for moving the automated driving vehicle to a car wash station before use of the automated driving vehicle is started.

5. A car wash judgment method, comprising:
acquiring traveling information of a vehicle;
retaining a predetermined car wash condition; and
judging whether or not acquired traveling information satisfies the predetermined car wash condition.
